(19) United States
(12) Patent Application Publication
(10) Pub. No.: US 2026/0009936 A1
(43) Pub. Date: Jan. 8, 2026

(54) DISPLAY ELEMENT COMPRISING PROTECTION FROM ULTRAVIOLET RADIATION

(71) Applicant: Continental Automotive Technologies GmbH, Hannover (DE)

(72) Inventors: Ali Haydar OK, Ulm (DE); Lena Maria BARNEFSKE, Frankfurt (DE)

(21) Appl. No.: 19/256,290

(22) Filed: Jul. 1, 2025

(30) Foreign Application Priority Data
Jul. 2, 2024 (DE) 10 2024 206 219.7

(51) Int. Cl. G02B 5/20; G02B 1/14

(52) U.S. Cl. CPC G02B 5/208; G02B 1/14

(57) ABSTRACT

A display element including protection from ultraviolet radiation. The display has a display panel and a cover glass arranged above the display panel. A functionality for protection from ultraviolet radiation is integrated into the cover glass. Alternatively a layer for protection from ultraviolet radiation is arranged on a bottom surface of the cover glass facing the display panel.

### BACKGROUND OF THE INVENTION

### 1. Field of the Invention

The present disclosure relates to a display element comprising protection from ultraviolet radiation.

### 2. Description of Related Art

Displays often contain optical components, which have a tendency to discolor, in particular to yellow, or to bleach, upon exposure to ultraviolet (UV) light. To avoid this a layer for protection from ultraviolet radiation may be applied to the display.

By way of example U.S. Pat. No. 8,932,737 describes a coating comprising a UV barrier layer, a hard coating layer arranged above the UV barrier layer and a hydrophobic coating arranged above the hard coating layer. The coating may be applied to a touchscreen of a mobile telephone for example.

U.S. Pat. No. 10,514,482 B2 describes a UV-resistant multilayer optical film, wherein the layers collectively reflect at least 50 percent of the incident UV light over a predetermined wavelength range. The film may be used for a liquid crystal display for example.

WO 2016/148 141 A1 describes a multilayer film in which at least 50 layers comprising a first and a second thermoplastic resin are arranged in alternate layers. Either the layers comprising the first resin or the layers comprising the second resin contain a dye, a UV absorber for absorbing blue light or both. The film may be used for a display for example.

As an alternative to applying a layer for protection from ultraviolet radiation to the display it is also possible to utilize optically clear adhesives (OCA) containing a UV blocker in the display. However, such adhesives with UV blockers are more costly than without UV blockers. The optical requirements of optically clear adhesives are also high. Optically clear adhesives with UV blockers already tend to be somewhat yellowish and yellow more rapidly, thus restricting their use.

### SUMMARY OF THE INVENTION

It is an object of one aspect of the invention to provide an improved display element comprising protection from ultraviolet radiation.

According to a first aspect of the invention a display element comprises:
a display panel;
a cover glass arranged above the display panel; and
a functionality for protection from ultraviolet radiation integrated into the cover glass or a layer for protection from ultraviolet radiation arranged on a bottom surface of the cover glass facing the display panel.

In a solution according to one aspect of the invention a functionality for protection from ultraviolet radiation is integrated into the cover glass or a layer for protection from ultraviolet radiation is applied to a bottom surface of the cover glass. Integrating such a functionality into the cover glass has the advantage that no additional UV protection is required. By contrast, applying a layer for protection from ultraviolet radiation to the bottom surface of the cover glass has the advantage that it need not be particularly resistant or protected from environmental influences by an additional protective layer. A greater number of materials for forming such a layer is therefore available. Such a layer is also more cost effective to produce than a layer arranged on the cover glass due to the less stringent requirements. The layer is preferably configured to protect from light having a wavelength below 380 nm.

In one aspect of the invention a further layer for protection from ultraviolet radiation is arranged on a top surface of the cover glass facing away from the display panel. While such a layer is exposed to environmental influences the layer arranged on the bottom surface of the cover glass means that damage to this layer arranged on the top surface is less disruptive. The requirements for stability are therefore less stringent than is the case in the prior art.

In one aspect of the invention the layer for protection from ultraviolet radiation is formed from a material that absorbs ultraviolet light. The material may be a material in which a dye or a UV absorber is a constituent of a polyurethane or a polysiloxane or another matrix for example.

In one aspect of the invention the layer for protection from ultraviolet radiation is formed from a material containing particles that absorb ultraviolet light. The material may be for example a polymer in which metal oxide particles, nanoparticles or particles based on benzophenone or another phenol are embedded. Suitable metal oxides are zinc oxide and titanium oxide for example.

In one aspect of the invention the layer for protection from ultraviolet radiation is implemented in the form of a coating applied to the cover glass. Such a coating is particularly thin and may be applied for example by sputtering, spray coating or plasma coating.

In one aspect of the invention the layer for protection from ultraviolet radiation is implemented in the form of a film bonded to the cover glass. Such a film has the advantage that it may be prefabricated in a separate process and therefore obtained from a supplier as required.

In one aspect of the invention the film is a multilayer film. This makes it possible for requirements that are difficult to reconcile or implement in one layer to be relocated into different layers.

In one aspect of the invention the multilayer film has an additional functionality. The additional functionality may especially be absorption of light in the blue spectral range. Some studies indicate that blue light may be harmful to the retina and may also have a disruptive effect on sleep patterns. Depending on the application it may therefore be advantageous to filter out or attenuate this light or else light of other spectral ranges.

In one aspect of the invention the functionality for protection from ultraviolet radiation is introduced into the cover glass by ion exchange. Processes based on ion exchange are well-suited to effect targeted alteration of properties of glasses.

In one aspect of the invention the display panel is a liquid crystal panel. The liquid crystal layer of a liquid crystal panel is susceptible to damage from incident ultraviolet light. The use of a solution according to the invention is therefore particularly advantageous for such a display panel.

A display element according to one aspect of the invention is preferably used for realizing a display apparatus, for example in a transport, a user device, a household appliance or a medical device.

Further features of the present invention will become apparent from the following description and the appended claims in conjunction with the figures.

### BRIEF DESCRIPTION OF THE DRAWINGS

FIG. 1 is a schematic diagram of a display element according to the invention;

FIG. 2 is a schematic diagram of a display element according to the invention;

FIG. 3 is a schematic diagram of a display element according to the invention;

FIG. 4 is a schematic diagram of a display element according to the invention; and

FIG. 5 is a schematic diagram of a transport which utilizes a display element.

### DETAILED DESCRIPTION OF THE PRESENTLY PREFERRED EMBODIMENTS

For a better understanding of the principles of the present invention, embodiments of the invention are more particularly described below with reference to the figures. Identical reference numerals are used for identical or functionally identical elements in the figures and are not necessarily described again for each figure. It goes without saying that the invention is not restricted to the embodiments represented and that the features described may also be combined or modified without departing from the scope of protection of the invention as defined in the appended claims.

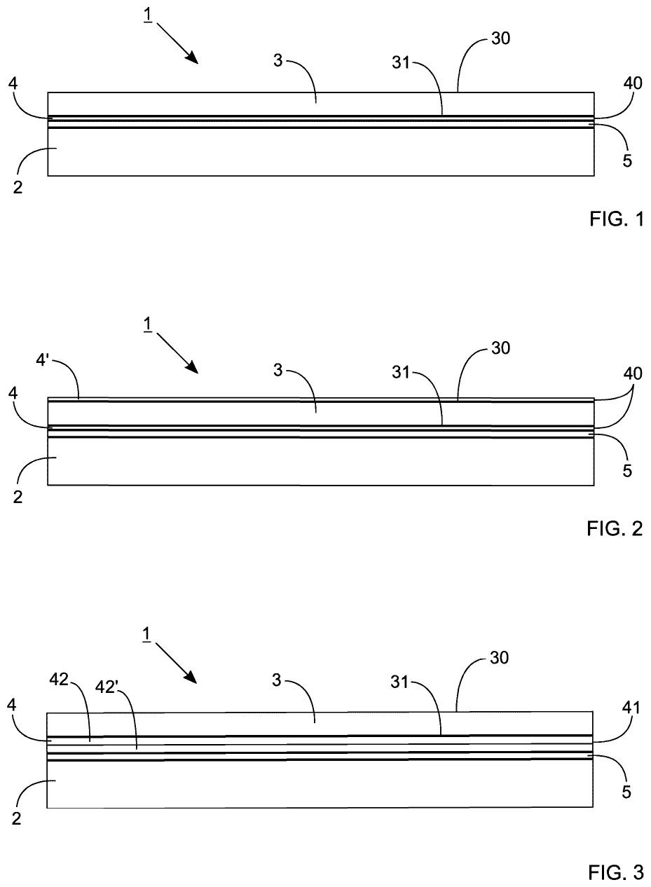

FIG. 1 is a schematic diagram of a first exemplary embodiment of a display element 1 according to the invention. The display element 1 comprises a display panel 2 and a cover glass 3 arranged above the display panel 2. The display panel 2 may be a liquid crystal panel for example. A layer 4 for protection from ultraviolet radiation is arranged on a bottom surface 30 of the cover glass 3 facing the display panel 2. The layer 4 for protection from ultraviolet radiation may be formed for example from a material which absorbs ultraviolet light, for example a material based on a polyurethane or a polysiloxane. The layer 4 for protection from ultraviolet radiation may alternatively also be formed from a material containing particles which absorb ultraviolet light. The material may be for example a polymer in which metal oxide particles, nanoparticles or particles based on benzophenone or another phenol are embedded. Suitable metal oxides are zinc oxide and titanium oxide for example. In the exemplary embodiment of FIG. 1 the layer 4 for protection from ultraviolet radiation is realized in the form of a coating 40. Such a coating 40 may be applied to the cover glass 3 by sputtering, spray coating or plasma coating for example. The display panel 2 and the cover glass 3 having the layer 4 for protection from ultraviolet radiation arranged on its bottom surface are joined to one another by a bonding layer 5. The bonding layer 5 may be formed for example by an optically clear adhesive or by an optically clear synthetic resin.

FIG. 2 shows a schematic diagram of a second exemplary embodiment of a display element 1 according to the invention. It largely corresponds to the display element 1 shown in FIG. 1 but in this exemplary embodiment a further layer 4′ for protection from ultraviolet radiation is arranged on the top surface 31 of the cover glass 3 facing away from the display panel 2. This may be composed of the same material or a different material as the layer 4 arranged on the bottom surface 30. In the illustrated example the further layer 4′ is also implemented in the form of a coating 40.

FIG. 3 shows a schematic diagram of a display element 1 according to the invention. It largely corresponds to the display element 1 shown in FIG. 1 but in this exemplary embodiment the layer 4 for protection from ultraviolet radiation is implemented in the form of a film 41 bonded to the cover glass 3. In this case the film 41 is implemented as a multilayer film 41. In FIG. 3 the layers 42, 42′ of the film are shown with an exaggerated thickness for the sake of clarity. A multilayer film 41 makes it possible for requirements that are difficult to reconcile or implement in one layer to be relocated into different layers 42, 42′. Additional functionalities may also be implemented. By way of example a first layer 42 can ensure protection from ultraviolet radiation while a second layer 42′ serves to attenuate light in the blue spectral range emitted by the display panel 2 in order, for example, to protect the eyes of a viewer.

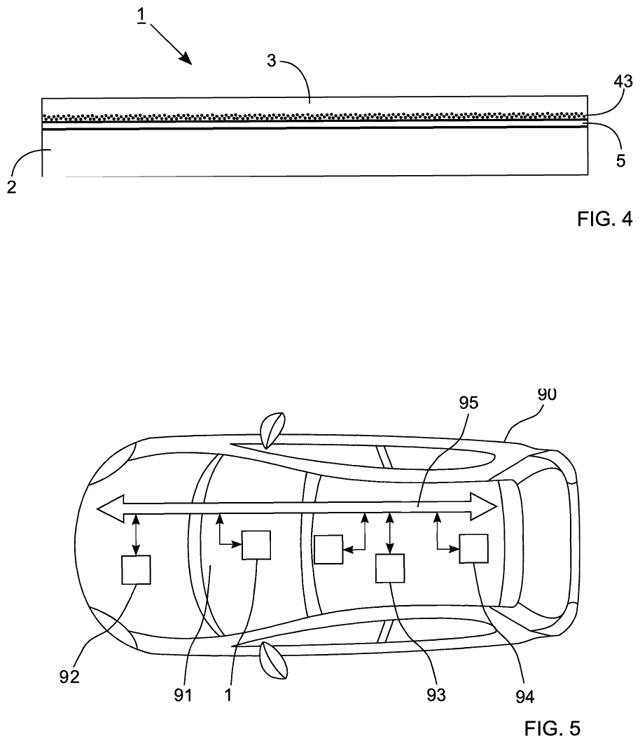

FIG. 4 shows a of a display element 1 according to the invention. It largely corresponds to the display element 1 shown in FIG. 1 but in this exemplary embodiment the functionality for protection from ultraviolet radiation is integrated into the cover glass 3. This is indicated in FIG. 4 by the dots in the interior of the cover glass 3. These mark a region 43 which offers protection from ultraviolet radiation. To integrate the functionality for protection from ultraviolet radiation into the cover glass 3, the cover glass 3 may be subjected for example to a process based on ion exchange.

FIG. 5 shows a schematic diagram of a mode of transport 90 utilizing a display element 1 according to the invention. The transport 90 is a motor vehicle in this example. The motor vehicle comprises a display element 1 according to the invention which in the example shown is arranged in an instrument panel 91. The display element 1 may be utilized to display instructions from a navigation system 92 for example. A data transfer unit 93 may be used to set up a connection to a backend, for example to obtain updated software for components of the motor vehicle. A memory 94 is present for storing data. Data exchange between the various components of the motor vehicle proceeds via a network 95.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A display element comprising:
a display panel;
a cover glass arranged above the display panel; and
a functionality for protection from ultraviolet radiation integrated into the cover glass or a layer for protection from ultraviolet radiation arranged on a bottom surface of the cover glass facing the display panel.

2. The display element as claimed in claim 1, comprising:
a further layer for protection from ultraviolet radiation arranged on a top surface of the cover glass facing away from the display panel.

3. The display element as claimed in claim 1, wherein the layer for protection from ultraviolet radiation is formed from a material that absorbs ultraviolet light.

4. The display element as claimed in claim 1, wherein the layer for protection from ultraviolet radiation is formed from a material containing particles that absorb ultraviolet light.

5. The display element as claimed in claim 1, wherein the layer for protection from ultraviolet radiation is a coating applied to the cover glass.

6. The display element as claimed in claim 1, wherein the layer for protection from ultraviolet radiation is a film bonded to the cover glass.

7. The display element as claimed in claim 6, wherein the film is a multilayer film.

8. The display element as claimed in claim 7, wherein the multilayer film has an additional functionality.

9. The display element as claimed in claim 8, wherein the additional functionality is absorption of light in a blue spectral range.

10. The display element as claimed in claim 1, wherein the functionality for protection from ultraviolet radiation is introduced into the cover glass by ion exchange.
